(19) United States
(12) Patent Application Publication
(10) Pub. No.: US 2008/0062175 A1
(43) Pub. Date: Mar. 13, 2008

(54) System for Acquiring Signals and for Displaying and Comparing Data from the Signals

(75) Inventor: Prashant Arya, Delhi (IN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/470,628

(22) Filed: Sep. 7, 2006

(51) Int. Cl. G06T 11/20

(52) U.S. Cl. 345/440

(57) ABSTRACT

A measurement system comprises a signal acquisition device for acquiring signals. A processor processes the signals to obtain a first series of data and a second series of data. A display device receives the first series of data and the second series of data. A first graph on the display device has a first graph first axis and a first graph second axis with the first series of data displayed thereon. A second graph on the display device has a second graph first axis and a second graph second axis with the second series of data displayed thereon. The first graph first axis has the same units and minimum and maximum first axis scale values as the second graph second axis. Also, the first graph second axis is recalibrated from having different minimum and maximum second axis scale values as the second graph second axis to having the same units and minimum and maximum second axis scale values as the second graph second axis.

### BACKGROUND OF THE INVENTION

The product brochure “Agilent OSS Wireless QoS Manager, The proven solution for wireless assurance to lead you into the world of 3G services”, copyrighted by Agilent Technologies, Inc. in 2004, describes a system for measuring wireless network performance. The system includes active test probes (see FIG. 1 of the product brochure) for receiving signals of a wireless network and taking performance data. The signals are processed to determine performance data.

FIG. 1 of the present disclosure is a reproduction of FIG. 4 of the product brochure and shows a typical line-graph 100. This graph illustrates a quality of service measurement, in this case the pass rate for Multimedia Message Service (MMS), as a function of calendar date. A line-graph is used to display the relationship between two variables. In FIG. 1, the variables are the calendar date and MMS pass rate. Each value of calendar date is plotted along the horizontal axis, also called the x-axis or abscissa 103, and the corresponding value of MMS pass rate is plotted along the vertical axis, also called the y-axis or ordinate 105. Each point on this graph represents an ordered pair of data: for each value of calendar date there is a corresponding value of MMS pass rate.

An exemplary data point 101 represents the MMS pass rate of 84% at calendar date 12 Mar. 04. The point is located 2 units (days) to the right of the y-axis (that is, 2 units along the x-axis) and 24 units (%) above the x-axis (that is, 24 units along the y-axis for a total y-value of 84%). The variable plotted along the x-axis is called the independent variable; the variable plotted along the y-axis is called the dependent variable.

Axis headings are provided, listing the name of the variable plotted along each axis and the units of the variable. The x-axis heading 107 is “Date (days)” and the y-axis heading 109 is “Pass Rate (%)”.

A title 111 “MMS Pass Rate (%)” is also included at the top of the graph.

The x-axis 103 includes x-axis ticks 113 each having a corresponding x-axis tick label 121. The y-axis 105 includes y-axis ticks 115 each having a corresponding y-axis tick label 123. In general the ticks 113, 115 are spaced at a predetermined distance from each other. The graph 100 is a linear graph so the ticks 113, 115 are evenly spaced along the axes. However, in other types of graphs which can be used in the present invention, such as graphs having logarithmic scales, the ticks 113, 115 are not evenly spaced.

The x-axis 103 is calibrated to have an x-axis scale 117, which starts at a minimum x-axis scale value, indicated by the reference number 125 and ends at a maximum x-axis scale value, indicated by the reference number 127. The minimum x-axis scale value 125 and maximum x-axis scale value 127 can have corresponding x-axis tick labels 121, but are not required to have such labels. The range of the x-axis scale 117 is the distance between the minimum and maximum variable values. In the graph 111 of FIG. 1 the x-axis scale 117 starts at a minimum value of “10 Mar. 2004” and ends at a maximum value of “24 Mar. 2004” and so the x-axis scale has a range of 14 days or 14 units.

The y-axis 105 is calibrated to have a y-axis scale 119 which starts at a minimum y-axis scale value 129 and ends at a maximum y-axis scale value 131. The minimum y-axis scale value 129 and maximum y-axis scale value 131 can have corresponding y-axis tick labels 123, but are not required to have such labels. The range of the y-axis scale 117 is the distance between the minimum and maximum y-variable values. In FIG. 1 the y-axis scale 119 starts at a minimum value of “60%” and ends at a maximum value of “95%” and so the y-axis scale has a range of 35% or 35 units.

FIG. 5 of the product brochure shows other types of graphs, in this case bar-graphs, illustrating performance data. One of the graphs shows the performance data for the “Data Transfer Time Maximum” and “Data Transfer Time Minimum” as a function of date and time of day. The other graph shows “Send Time” and “Receive Time”, also as a function of date and time of day. These performance data are used to determine the QoS (quality of service) of a wireless service which a user of the wireless network experiences.

FIGS. 2(A) and (B) and FIG. 3 of the present disclosure similarly illustrate prior-art bar-graphs of a performance measurement (in these examples the performance measurement has units of time) versus time of day.

The display monitors of prior-art performance measurement systems will often display the bar-graphs of FIG. 2 side-by-side or one-above-the-other so that the user can compare the values of key performance indicators at corresponding x-axis values, where the x-axis values can have units of time, for example.

FIG. 2(A) plots a first series of performance data. In FIG. 2(A) the range of the performance data is roughly from 2 seconds to 10 seconds. Therefore the y-axis is calibrated to a scale from 0 to 12 seconds, a range of 12 seconds, to allow a good view of the entire range of y-values.

FIG. 2(B) plots a second series of performance data. In FIG. 2(B) the range of the performance data is roughly from 10 seconds to 21 seconds. Therefore the y-axis is calibrated to a scale from 0 to 25 seconds, a range of 25 seconds, to allow a good view of the entire range of y-values.

Viewing the bar-graphs of FIGS. 2(A) and (B) when placed side-by-side or one-above-the-other can be problematic, however, because the calibration of the y-axes to different scales of the same units can lead to confusion. For example, if a user looks at the height of the bar of the first series of data (Series 1) at the time 11:15 of FIG. 2(A) he will see that it is higher than the bar of the second series of data (Series 2) at the time 11:15 of FIG. 2(B), and thus he will think that the y-axis time value is greater in FIG. 2(A) than FIG. 2(B). However, upon more careful examination, the user will see that the y-axis time value (10 seconds) of the first series of data (Series 1) at the time 11:15 in FIG. 2(A) is actually less than the y-axis time value (12 seconds) of the second series of data (Series 2) at the time 11:15 in FIG. 2(B). The user has to repeatedly check the values of the y-axis labels of the individual graphs in order to attribute approximate values to the heights of the bars in the graph and to accurately compare the values of the bars. Thus, comparison of the two series of the two graphs becomes difficult due to the different scales of the y-axes.

One way the prior art gets around this problem is to plot the first and second series bar-graphs for comparison of y-values on the same bar-graph having a common x-axis and y-axis with common scales. FIG. 3 shows the data bars of the first and second series of data of FIGS. 2(A) and (B) combined onto a single bar-graph. It thus becomes easier to compare the heights of the bars of the first and second series of data. Looking again at the x-axis time of day of 11:15, it can be clearly seen that the y-axis time value for the first series of data (Series 1) is less than the value for the second series of data (Series 2). There is no need to carefully look at the y-axis labels in order to accurately compare the relative values of the bars of the first and second series as when the separate graphs of FIGS. 1(A) and (B) are used.

However, this method of plotting more than one series of values on a single graph has its own problems. For example, when too many series and too many bars are plotted on a single graph, the graph can become cluttered and difficult to view.

The same problems described above similarly apply to other types of graphs/plots/charts in addition to bar-graphs, including line-graphs, pictographs, pie charts, scatter plots, and other types of graphs/plots/charts.

It would be desirable to provide a performance measurement display on a monitor of a performance measurement system that would allow for the quick and accurate comparison of any data, whereby the data can be performance data or performance data of a telecommunications network or performance data of a wireless telecommunications network.

### SUMMARY OF THE INVENTION

The present invention provides a performance measurement display on a monitor of a performance measurement system that allows for quick and accurate comparison of any data, whereby the data can be performance data or performance data of a telecommunications network or performance data of a wireless telecommunications network.

In more general terms, one embodiment of the invention is a measurement system comprising a signal acquisition device for acquiring signals. A processor processes the signals to obtain a first series of data and a second series of data. A display device receives the first series of data and the second series of data. A first graph on the display device has a first graph first axis and a first graph second axis with the first series of data displayed thereon. A second graph on the display device has a second graph first axis and a second graph second axis with the second series of data displayed thereon. The first graph first axis has the same units and minimum and maximum first axis scale values as the second graph second axis. Also, the first graph second axis is recalibrated from having different minimum and maximum second axis scale values as the second graph second axis to having the same units and minimum and maximum second axis scale values as the second graph second axis.

In more general terms, one embodiment generates graphs for displaying data by acquiring signals using a signal acquisition device. The signals are processed to obtain a first series of data and a second series of data comprising independent and dependent variables. A search is performed of the dependent variables of the first series of data and the second series of data and the minimum dependent variable value and maximum dependent variable value are determined. The scale of a second axis of a first graph and of a second graph are determined such that the scales of the second axes of the first and second graphs have the same units and minimum and maximum second axis scale values; and the minimum second axis scale value is no larger than the minimum dependent variable value and the maximum second axis scale value is no smaller than the maximum dependent variable value so that the entire range of the dependent variables of the first series is displayed at or between the minimum and maximum second axis scale values. A display device displays the first series of data on the first graph and the second series of data on the second graph.

### BRIEF DESCRIPTION OF THE DRAWINGS

Further preferred features of the invention will now be described for the sake of example only with reference to the following figures, in which:

FIG. 1 shows a typical line-graph of the prior art.

FIGS. 2(A) and 2(B) are bar-graphs a first series and second series of performance data, respectively.

FIG. 3 shows data bars of the first and second series of data of FIGS. 2(A) and (B) combined onto a single bar-graph.

FIG. 4 illustrates a system for measuring the quality of service which a user of a wireless network experiences incorporating the present invention.

FIGS. 5(A) and 5(B) show a first series of data (Series 1) and a second series of data (Series 2), respectively, displayed on graphs of the present invention.

FIG. 6 is flowchart of the method of the invention of FIGS. 5(A) and 5(B).

FIGS. 7(A) and 7(b) show a first series of data (Series 1) and a second series of data (Series 2), respectively, displayed on graphs as part of the invention of FIG. 4 wherein the y-axis time values of one of the series of data are significantly smaller than y-axis time values for the other series of data.

FIGS. 8(A), 8(B) show a first series of data (Series 1) and a second series of data (Series 2), respectively, displayed on a graph as part of the invention of FIG. 4 wherein the y-axis time values at particular x-axis values of one of the series of data are very close in value to y-axis time values at the corresponding x-axis values of the other series of data.

FIG. 8(C) shows data bars of the first and second series of data of FIGS. 8(A) and (B) combined onto a single bar-graph to allow a more detailed comparison of bar heights.

### DETAILED DESCRIPTION

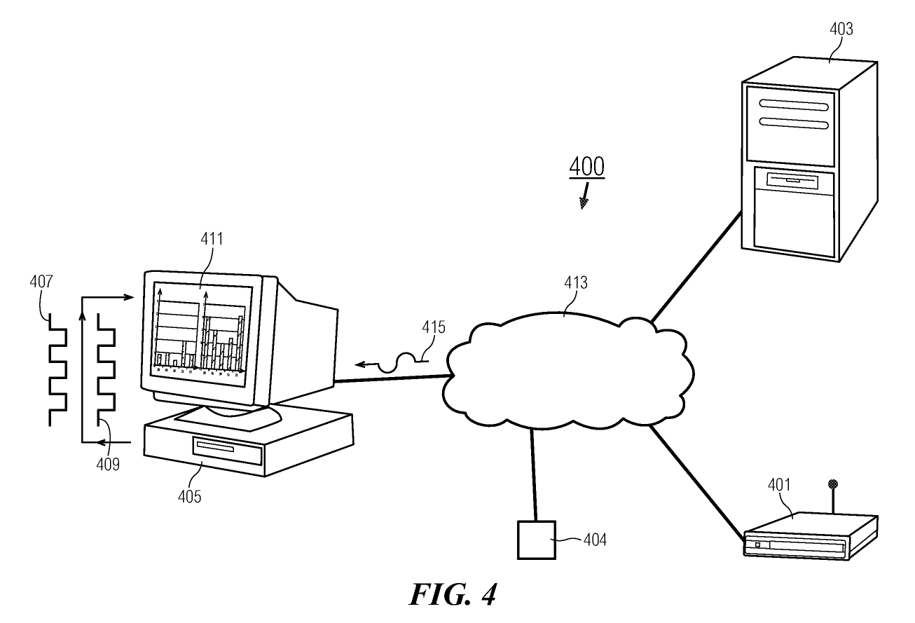

FIG. 4 illustrates a system 400 incorporating the present invention for measuring the quality of service which a user of a wireless network experiences. Active test probes 401 serve as a signal acquisition device for acquiring signals 415 from the wireless network. Alternatively, a computer 403 can serve as the signal acquisition device. The signals 415 are then processed by a processor of the computer 405, to obtain data. The data can be a first series of data (Series 1) 407 and a second series of data (Series 2) 409. For example, the first series of data (Series 1) 407 might represent a data receive time in seconds while the second series of data (Series 2) 409 might represent a data send time in seconds. The various components of the system 400 can communicate through a path 413 which can be a local area network (LAN) or the INTERNET for example.

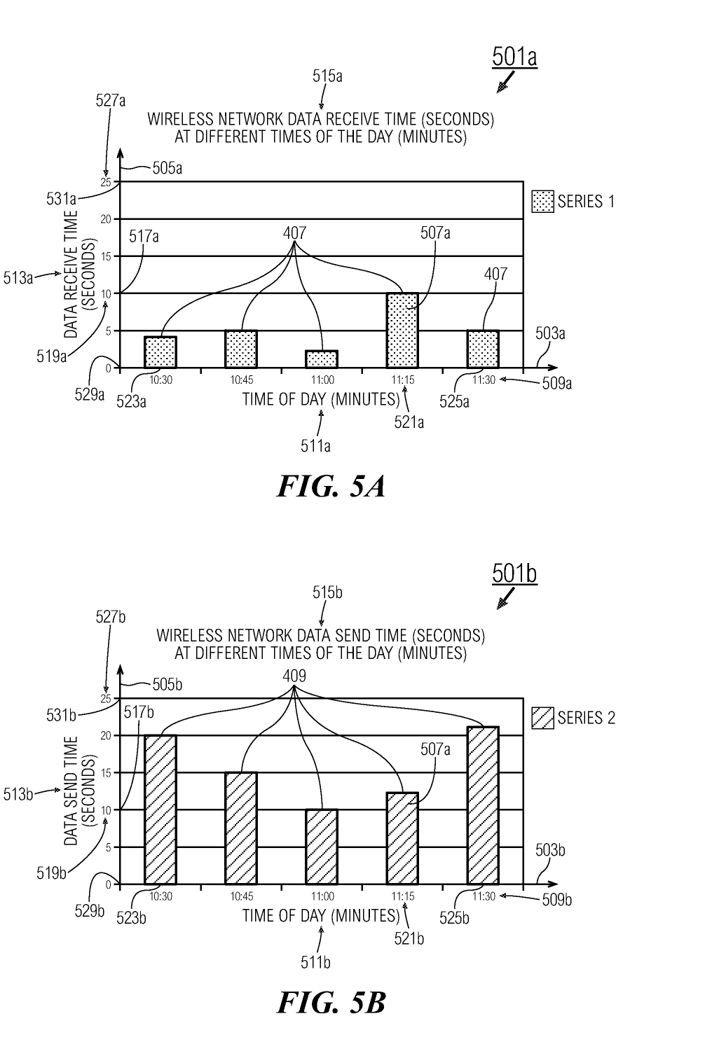

A display device 411 receives the first series of data (Series 1) 407 and the second series of data (Series 2) 409 from the computer 405. As shown in more detail in FIG. 5a, the first series of data (Series 1) 407 is displayed on a first graph 501a on the display device 411 having a first graph first axis 503a and a first graph second axis 505a. As shown in FIG. 5(b), the second series of data (Series 2) 409 is displayed on a second graph 501b on the display device 411 having a second graph first axis 503b and a second graph second axis 505b. The graphs can be bar-graphs, the first graph first axis 503a can be an x-axis, the first graph second axis 505a can be a y-axis, the second graph first axis 503b can be an x-axis and the second graph second axes 505b can be a y-axis.

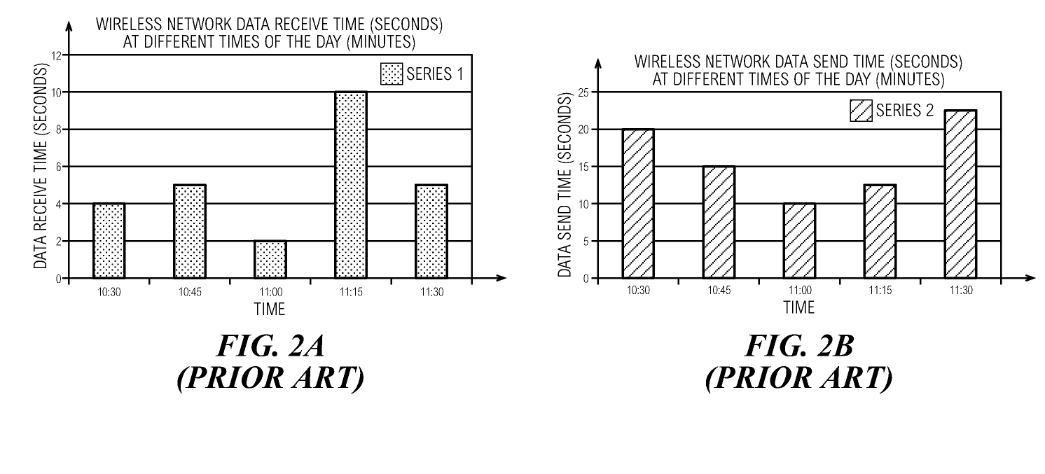

The graphs and data of FIGS. 5(A) and 5(B) are the same as those of FIGS. 2(A) and 2(B) except that a y-scale 527a of the graph of FIG. 5A has been calibrated as per an embodiment of the present invention.

The first graph 501 a illustrates a quality of service measurement, in this case the data receive time, as a function of the time of day. A bar-graph is used to display the relationship between two variables. The variables are the time of day and data receive time. Each value of the time of day is plotted along the first graph first axis 503a, which can be a horizontal axis, x-axis or abscissa, and the corresponding value of data receive time is plotted along the first graph second axis 505a, which can be a vertical axis, y-axis or ordinate. Each point on this graph represents an ordered pair of data: for values of time of day there are corresponding values of data receive time.

An exemplary data bar 507a of FIG. 5(a) represents the data receive time of 10 seconds at the time of day 11:15. The bars of the bar-graph 501a are separated by 15 minute intervals. Thus the data bar 507a is separated by 15 one-minute units, or a total of 15 minutes, along the x-axis from the adjacent data bars located at times of 11:00 and 11:30. The data bar 507a extends 10 one-second units, or a total of 10 seconds, above the x-axis 503a.

Axis headings are provided listing the name of the variable plotted along each axis and the units of the variable. The x-axis heading 511a is “Time of Day (Minutes)” and the y-axis heading 513a is “Data receive time (Seconds)”.

A title 515a “Wireless Network Data Receive Time (Seconds) at Different Times of Day (Minutes)” is also included at the top of the graph.

The x-axis 503a includes x-axis tick labels 521a corresponding to the data bars of first series of data (Series 1) 407. The y-axis 505a includes y-axis ticks 517a each having a corresponding y-axis tick label 519a. In general the ticks 517a are spaced at a predetermined distance from each other. The bar-graph 501a is a linear graph so the ticks 517a are evenly spaced along the y-axis. However, in other types of graphs which can be used in the present invention, such as graphs having logarithmic scales, the ticks 517a are not evenly spaced.

The x-axis 503a is calibrated to have an x-axis scale 509a, which starts at a minimum x-axis scale value, indicated by the reference number 523a and ends at a maximum x-axis scale value, indicated by the reference number 525a. The minimum x-axis scale value 523a and maximum x-axis scale value 525a can have corresponding x-axis tick labels 521a, but are not required to have such labels. The range of the x-axis scale 509a is the distance between the minimum and maximum variable values. The x-axis scale 509a starts at a minimum value of “10:30” and ends at a maximum value of “11:30” and so the x-axis scale has a range of 60 minutes.

The y-axis 505a is calibrated to have the y-axis scale 527a, which starts at a minimum y-axis scale value 529a and ends at a maximum x-axis scale value 531a. The minimum y-axis scale value 529a and maximum y-axis scale value 531 a can have corresponding y-axis tick labels 519a, but are not required to have such labels. The range of the y-axis scale 527a is the distance between the minimum and maximum variable values. The y-axis scale 527a starts at a minimum value of “0 seconds” and ends at a maximum value of “25 seconds” and so the y-axis scale has a range of 25 seconds or 25 units.

The second graph 501b of FIG. 5(b) is also displayed on the display device 411 and is side by side with the first graph 501a. The second graph 501b is similar to the first graph 501a except that the dependent variable plotted is the data send time rather than the data Receive Time.

The graphs 501a, 501b, rather than being displayed side by side as illustrated in FIG. 5, can be displayed one above the other or can be displayed in other relative positions so as to provide ease of comparison of the first series of data (Series 1) 407 and a second series of data (Series 2) 409.

Additionally, the first graph and second graph can be displayed one-above-the-other or side-by-side in the same window or with common control.

The data send time shown on the second graph 501b is also a quality of service measurement and is shown as a function of the time of day, for comparison with the first graph 501a. Each value of time of day is plotted along the horizontal axis 503b, and the corresponding value of data send time is plotted along the vertical axis 505b.

An exemplary data bar 507b of the second graph 501b represents the data send time of 12 seconds at the time of day 11:15. The data bar 507b extends 12 one-second units, or a total of 12 seconds, above the x-axis.

The x-axis heading 511b is “Time of Day (Minutes)” and the y-axis heading 513b is “Data Send Time (Seconds)”.

A title 515b “Wireless Network Data Send Time (Seconds) at Different Times of Day (Minutes)” is also included at the top of the graph.

The x-axis 503b is calibrated to have an x-axis scale 509b, which starts at a minimum x-axis scale value, indicated by the reference number 523b and ends at a maximum x-axis scale value, indicated by the reference number 525b. The minimum x-axis scale value 523b and maximum x-axis scale value 525b can have corresponding x-axis tick labels 521b, but are not required to have such labels. The range of the x-axis scale 509b is the distance between the minimum and maximum variable values. The x-axis scale 509b starts at a minimum value of “10:30” and ends at a maximum value of “11:30” and so the x-axis scale has a range of 60 minutes.

The y-axis 505b is calibrated to have an y-axis scale 527b, which starts at a minimum y-axis scale value 529b and ends at a maximum x-axis scale value 531b. The minimum y-axis scale value 529b and maximum y-axis scale value 531b can have corresponding y-axis tick labels 519b, but are not required to have such labels. The range of the y-axis scale 527b is the distance between the minimum and maximum variable values. The y-axis scale 527b starts at a minimum value of “0 seconds” and ends at a maximum value of “25 seconds” and so the y-axis scale has a range of 25 seconds or 25 units.

As shown in FIG. 5, the units and scale 509a of the first graph first axis 503a are the same as the units and scale 509b of the second graph first axis 525. Also, the units and scale 527a of the first graph second axis 527a are the same as the units and scale 527b of the second graph second axis 527b. This makes it easier to compare the heights of the bars of the first series of data (Series 1) 407 and the bars of the second series of data (Series 2) 409 without needing to repeatedly check the labels of the axes.

Common scales 527a,b and/or 509a,b for the first and second graphs 501a and 501b are calibrated and output to the display device 411 using the following steps:

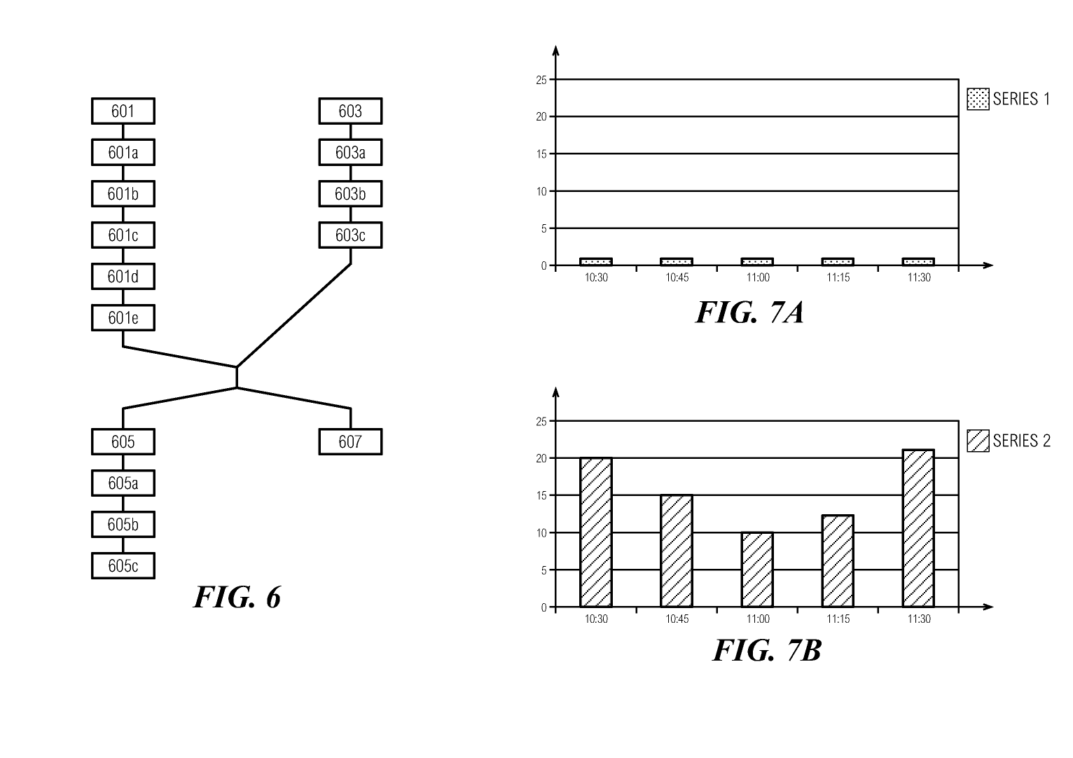

601: Calibrate the scale 509a,b for the x-axes 503a, 503b using the following sub-steps illustrated in the flowchart of FIG. 6 and executed by the computer 405 of FIG. 4:

601a: A combined search of the first series of data (Series 1) 407 and the second series of data (Series 2) 409 is performed to determine the minimum and maximum values for the independent variables (x-variables) to be plotted. For the data 407, 409 it is found that the minimum values are “10:30” and the maximum values are “11:30”. Thus the x-axis scales should go from at least “10:30” to “11:30”.

601b: The range of the x-axis scales 509a,b are calculated. The independent variables (x-variables) have a minimum value of “10:30” and a maximum value of “11:30”. So the x-axis scales 509a,b can start at a minimum value of “10:30” and end at a maximum value of “11:30” and so the x-axis scales 509a,b have a range of at least 60 minutes.

Thus, the scales 509a,b are calibrated such that they have the same units, minimum x-axis scale value 523a,b and maximum x-axis scale value 525a,b. Also, the minimum x-axis scale value 523a,b is no larger than the minimum independent variable value (“10:30”) and the maximum x-axis scale value 525a,b is no smaller than the maximum independent variable value (“11:30”) so that the entire range of the independent variables of the first and second series of data 407, 409 is displayed at or between the minimum and maximum second axis scale values.

601c: The number of bars for the bar-graph is determined based on the number of different values or ticks from among the independent variables to be displayed in each of the series of data 407, 409. Thus, the number of bars is determined to be five (5).

601d: The spacing, S, between the data bars is determined from:

S=R/(N−1),

where “R” is the range of the x-axis scales=60 minutes

and “N” is the number of data bars=5,

resulting in a value for the spacing of 15 minutes between the data bars.

601e: From the data of 601a and 601d it is determined to set the scales 509a, b such that data bars are placed at “10:30”, “10:45, “11:00”, “11:15” and “11:30”.

603: Calibrate the scale 527a,b for the y-axes 505a, 505b using the following sub-steps illustrated in the flowchart of FIG. 6 and executed by the computer 405 of FIG. 4.

603a: A combined search of the first series of data (Series 1) 407 and the second series of data (Series 2) 409 is performed to determine the minimum and maximum values for the dependent variables (y-variables) to be plotted. For the data 407, 409 it is found that the minimum values are “2 seconds” (the third data bar of FIG. 5(a)) and the maximum values are “21 seconds” (the last data bar of FIG. 5(b)). Thus the y-axis scales should go from at least “2 seconds” to “21 seconds”.

603b: The range of the y-axis scales 527a,b are calculated. The dependent variables (y-variables) have a minimum value of “2 seconds” and a maximum value of “21 seconds”. So the y-axis scales 527a,b can start at a minimum value of “2 seconds” and end at a maximum value of “21 seconds” and so the y-axis scales 509a,b have a range of at least 19 seconds.

Thus, the scales 527a,b are calibrated such that they have the same units, minimum y-axis scale value 529a,b and maximum y-axis scale value 531a,b. Also, the minimum y-axis scale value 529a,b is no larger than the minimum dependent variable value (“2 seconds”) and the maximum y-axis scale value 531a,b is no smaller than the maximum independent variable value (“21 seconds”) so that the entire range of the independent variables of the first and second series of data 407, 409 is displayed at or between the minimum and maximum second axis scale values.

603c: It can be pre-determined that the spacing between the y-axis tick labels 519a,b is to be “5 seconds”. Then the minimum y-axis scale value 529a,b is set as the next multiple of “5 seconds” smaller than the minimum dependent variable value. The maximum y-axis scale value 531a,b is set as the next multiple of “5 seconds” larger than the maximum dependent variable value. Thus the y-axis scales 527a,b are set to start a minimum value of “0 seconds” and end at a maximum value of “25 seconds” providing ranges for the y-axis scales 509a,b of 25 seconds.

The system 400 of the present invention is not limited to the acquisition of only the first series of data (Series 1) 407 and the second series of data (Series 2) 409. Also, the display device 411 is not limited to displaying only the first series of data (Series 1) 407 and the second series of data (Series 2) 409. Rather, third, fourth, fifth or more series of data (an arbitrary number “N” of series of data) can be acquired and displayed on third, fourth, fifth or more graphs (an arbitrary number “M” of graphs) on the display device 411.

The Step 601 and Sub-Steps 601a-e can be modified, according to an embodiment of the invention, to calibrate x-axis scales 509a,b for the “M” graphs, each one displaying one of the “N” series of data.

Also, the Step 603 and Sub-Steps 603a-c can be modified, according to an embodiment of the invention, to calibrate y-axis scales 537a,b for the “M” graphs, each one displaying one of the “N” series of data. The Step 603 and Sub-Steps 603a-c illustrated in FIG. 6 for calibrating y-axes become, for “M” graphs, each one displaying one of the “N” series of data:

603: Calibrate the scale 527a,b for the y-axes 505a, 505b using the following sub-steps illustrated in the flowchart of FIG. 6 and executed by the computer 405 of FIG. 4:

603a: A combined search of the “N” series of data is performed to determine the minimum and maximum values for the dependent variables (y-variables) to be plotted.

603b: The range of the y-axis scales are calculated.

603c: It can be pre-determined that the spacing between the y-axis tick labels is to be “5 seconds”. Then the minimum y-axis scale value is set as the next multiple of “5 seconds” smaller than the minimum dependent variable value. The maximum y-axis scale value is set as the next multiple of “5 seconds” larger than the maximum dependent variable value.

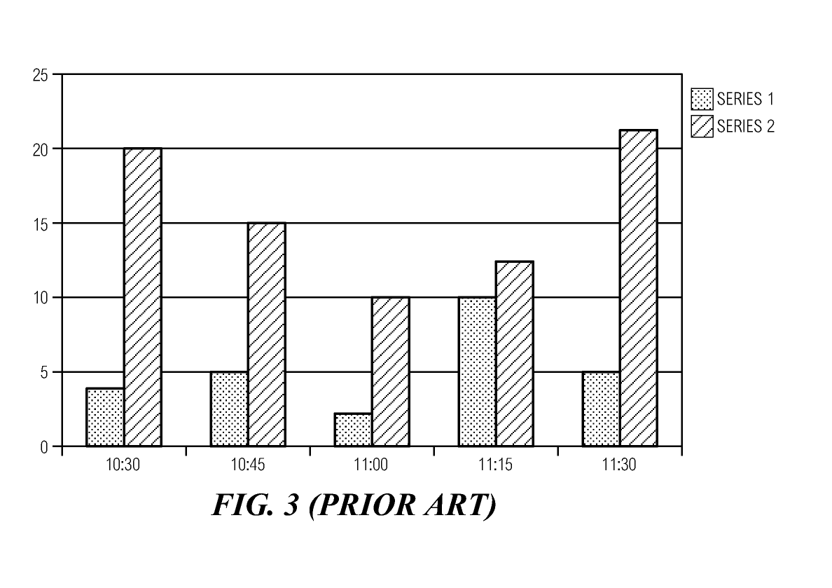

In other embodiments, two or more graphs are displayed on the display device 411 as in FIG. 5, and additionally one or more of the graphs displays more than one series of data as in the prior art graph of FIG. 3. This embodiment includes the feature that at least two of the graphs feature both of their first axes having the same units and scale and both of their second axes having the same units and scale.

FIGS. 7(A) and 7(b) illustrate the situation when the y-axis time values of one of the series of data are significantly smaller than y-axis time values for another of the series of data. This can occur when any one of the “N” series of data has a y-axis time value that differs by a magnitude of 10 to 100 or more compared to a y-axis time value belonging to another of the series of data. In the particular example of FIGS. 7(A) and 7(B), the calibration of y-axes to the same scale has been useful because it has made it easy to see that the series of data displayed in FIG. 7(B) has much larger y-axis time values than the series of data displayed in FIG. 7(A). If it is required to view the series of data displayed in FIG. 7(A) in more detail, however, Step 605 of FIG. 6 can be performed to re-scale the y-axis of the graph of FIG. 7(A). Thus, Step 605 provides for the re-calibrating one or more of the scales to a different scale. In general, the Step 605 can be applied to re-calibrate any of the scales of the “M” numbers of graphs as follows:

605a: A search of the series of data of the graph having the scale to be re-calibrated is performed (for example a search the first series of data 407 in FIG. 5(a)) to determine the minimum and maximum values for the variables to be plotted.

605b: The range of the scales is calculated (the range of scales is “8 seconds” in the example of FIG. 5(a))

605c: It can be pre-determined that the spacing between the tick labels is to be “2 seconds”. Then the minimum axis scale value is set as the next multiple of “2 seconds” smaller than the minimum dependent variable value (“0 seconds” in the example of FIG. 5(a)). The maximum axis scale value is set as the next multiple of “2 seconds” larger than the maximum dependent variable value (“12 seconds” in the example of FIG. 5(a)).

Using the graphs 501a,b of FIG. 5 as a specific example, after displaying the graphs 501a,b adjacent to each other on the display device 411, the y-axis scale 527a of the y-axis 505a of the graph 501a is recalibrated by executing the Step 605 and Sub-Steps 605a-c on the computer 405 resulting in the graph of FIG. 2(a) to allow better viewing of the first series of data (Series 1). The y-axis scale 527b of the y-axis 505b of the graph 501b can similarly be recalibrated for a more detailed view.

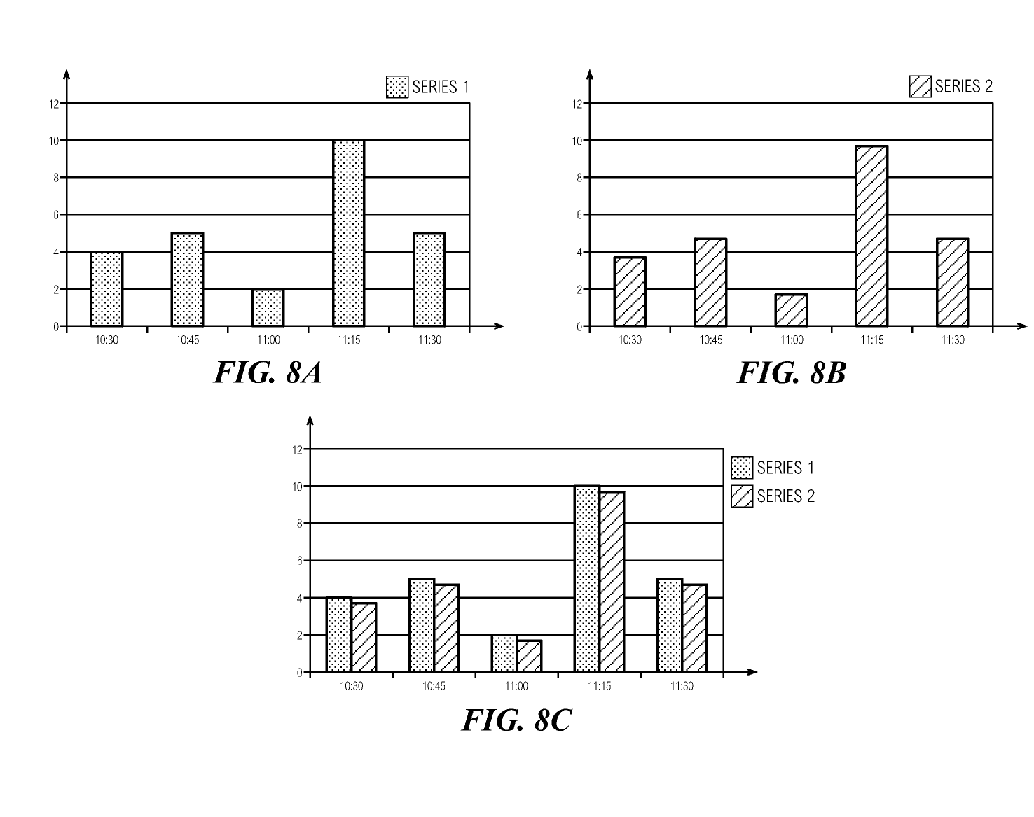

FIGS. 8(A), 8(B) and 8(C) illustrate the situation when the y-axis time values at particular x-axis values of one of the series of data are very close in value to the y-axis time values at the corresponding x-axis values of the other series of data. In the particular example of FIGS. 8(A) and 8(B), the calibration of y-axes to the same scale has been useful because it has made it easy to see that the series of data displayed in FIG. 8(B) has y-axis time values very similar to the series of data displayed in FIG. 8(A). If it is required to determine if the time values differ slightly from each other, however, Step 607 of FIG. 6 can be performed to combine the first and second data series of FIGS. 8(a) and 8(b) into the single graph of FIG. 8(C). In another example, the method of Step 607 can be used to combine the graphs 501a,b of FIGS. 5(A) and 5(B) into the format of the graph of FIG. 3.

In this embodiment, when fewer than a certain number “N” of series of data are to be displayed on the display device 411, the graph can be formatted as in FIG. 3, but then the computer 405 can automatically switch the format to that of FIGS. 5(A) and 5(B) with two or more separate graphs having the same scales when “N” or more series of data are to be displayed. For example, the graph of FIG. 3 might not seem cluttered with only two series of data displayed, but might become very cluttered with 4 series of data displayed. When fewer than 4 series of data are to be displayed on the display device 411, the graph can be formatted as in FIG. 3, but then the computer 405 can automatically switch the format to that of FIG. 5 with the series of data divided between two or more separate graphs having the same scales when 4 or more series of data are to be displayed.

The graphs and series of data displayed on the display device 411 can be switched between the formats of FIG. 2, FIG. 3 and FIG. 5 under user control or according to an automated algorithm.

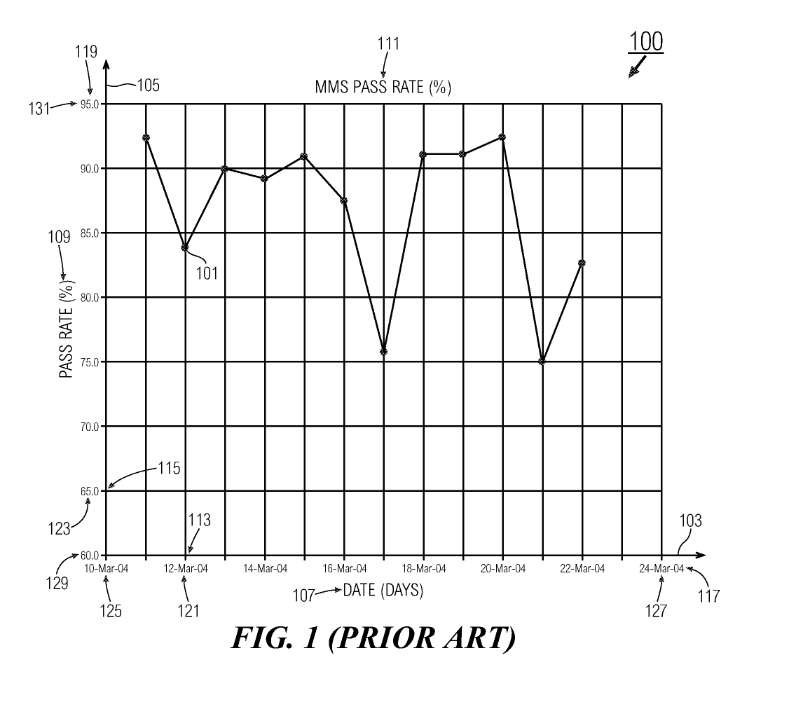

The present invention is also not limited to bar-graphs, but can also apply to line-graphs, pictographs, pie charts, scatter plots, and other types of graphs/plots/charts. For example, the graphs 501a,b of FIGS. 5(A) and 5(B) can be line-graphs as in FIG. 1.

The series of data displayed with respect to FIG. 5 can have values other than transfer time vs. time of day. For example the y-axis values can be data rate (in Kbytes/sec or other measurement units), a percentage (for example MMS pass rate as in FIG. 1) or other types of values. Also, rather than time of day, the x-axis values can be locations, distances, customers, bandwidth, dates or other types of values.

The display device 411 be comprised of a single computer monitor or can be comprised of two or more computer monitors, for example. The display device could also be other types of display devices now known or developed in the future.

In the foregoing specification, the invention has been described with reference to specific exemplary embodiments thereof. The specification and drawings are, accordingly, to be regarded in an illustrative sense rather than a restrictive sense.

1. A measurement system comprising:
a signal acquisition device for acquiring signals;
a processor for processing the signals to obtain a first series of data and a second series of data;
a display device which receives the first series of data and the second series of data;
a first graph on the display device having a first graph first axis and a first graph second axis with the first series of data displayed thereon;
a second graph on the display device having a second graph first axis and a second graph second axis with the second series of data displayed thereon;
and wherein:
the first graph first axis has the same units and minimum and maximum first axis scale values as the second graph first axis; and
the first graph second axis is recalibrated from having different minimum and maximum second axis scale values as the second graph second axis to having the same units and minimum and maximum second axis scale values as the second graph second axis.

2. The system of claim 1, further comprising:
dependent variables of the first and second series of data;
and wherein the minimum and maximum second axis scale values of the first and second graphs are such that the entire range of the dependent variables of the first and second series of data are displayed between the minimum and maximum second axis scale values of the second axes of the first and second graphs.

3. The system of claim 2 wherein the minimum and maximum first axis scale values of the first and second graphs are such that the entire range of the dependent variables of the first and second series of data are displayed between the minimum and maximum second axis scale values of the first axes of the first and second graphs.

4. The system of claim 1, wherein the first graph first axis is an x-axis, the first graph second axis is a y-axis, the second graph first axis is an x-axis and the second graph second axes is a y-axis.

5. The system of claim 1, wherein the first graph and second graph are displayed side-by-side.

6. The system of claim 1, wherein the first graph and second graph are displayed one-above-the-other.

7. The system of claim 1, wherein the first graph and second graph are displayed one-above-the-other or side-by-side in the same window.

8. The system of claim 1, wherein the first graph and second graph are displayed one-above-the-other or side-by-side with common control.

9. The system of claim 1, wherein the first and second graphs are bar-graphs.

10. The system of claim 1, wherein the first and second graphs are of the same type and are selected from the set consisting of: column graphs, line-graphs, pictographs, pie charts and scatter plots.

11. The system of claim 1, wherein the signal acquisition device is a test probe for acquiring signals from a wireless network.

12. The system of claim 1, wherein the signal acquisition device is a computer.

13. The system of claim 1, wherein the signal acquisition device is a test and measurement apparatus.

14. The system of claim 1, wherein the data displayed on the first and second graphs represents the performance of a wireless network.

15. The system of claim 1, wherein the first graph first axis and second graph first axis have units of time of day and the first graph second axis and second graph second axes have units of time.

16. The system of claim 11, wherein a comparison of the first and second graphs determines the quality of service which a user of the wireless network experiences.

17. The system of claim 1, further comprising:
a third graph displaying both the first and second series of data on the display device; and
a switch for switching between displaying the first and second graphs on the display device and displaying the third graph on the display device.

18. The system of claim 17, wherein the switch is controlled by a user of the system.

19. The system of claim 17, wherein the switch is controlled automatically by the processor.

20. The system of claim 1, wherein:
at least three series of data are displayed on at least three graphs with a different one of the series of data displayed on each graph; and
the second axes of the graphs have the same units and minimum and maximum second axis scale values.

21. The system of claim 20, wherein the first axes of the graphs have the same units and minimum and maximum first axis scale values.

22. The system of claim 1, further comprising a switch for switching between a first display configuration displaying the first and second graphs on the display device and a second display configuration displaying the first and second graphs with the first graph having a recalibrated second axis scale such that the first graph second axis has different maximum second axis scale values than the second graph second axis.
